(19) United States
(12) Patent Application Publication
(10) Pub. No.: US 2023/0257000 A1
(43) Pub. Date: Aug. 17, 2023

(54) SYSTEM AND METHOD FOR DETECTING AN OBSTACLE IN AN AREA SURROUNDING A MOTOR VEHICLE

(71) Applicant: RENAULT S.A.S, Boulogne-Billancourt (FR)

(72) Inventors: Jorge BELTRAN DE LA CITA, Getafe (ES); Vicente MILANES, Boulogne-Billancourt (FR); Carlos GUINDEL GOMEZ, Collado Villalba (ES); Fernando GARCIA FERNANDEZ, Madrid (ES); Irene CORTES LAFUENTE, Calatayud (ES)

(73) Assignee: RENAULT S.A.S, Boulogne-Billancourt (FR)

(21) Appl. No.: 18/004,033

(22) PCT Filed: Jun. 7, 2021
(86) PCT No.: PCT/EP2021/065118

§ 371 Date: Apr. 26, 2023

(30) Foreign Application Priority Data
Jul. 1, 2020 (FR) 2006963

(51) Int. Cl. B60W 60/00; G01S 17/931; G01S 17/89; B60W 30/09

(52) U.S. Cl. CPC B60W 60/0016; G01S 17/931; G01S 17/89; B60W 30/09; B60W 2420/42; B60W 2556/60

(57) ABSTRACT

The invention relates to a detection method implemented in a vehicle for detecting the presence of an obstacle in an area surrounding the vehicle from data from a perception system comprising:—a LIDAR configured to perform a 360° scan of the area surrounding the vehicle;—five cameras, each of the cameras being configured to capture at least one image (I₂, I₃, I₄, I₅, I₆) in an angular portion of the area surrounding the vehicle; the method being characterised in that it comprises:—a step (100) of scanning the area surrounding the vehicle by means of the LIDAR to obtain a point cloud (31) of the obstacle;—for each camera, a step (200) of capturing an image (I₂, I₃, I₄, I₅, I₆) to obtain a 2D representation of the obstacle located in the angular portion associated with the camera;—for each captured image (I₂, I₃, I₄, I₅, I₆), a step (300) of assigning the points in the point cloud (31) corresponding to the 2D representation of the obstacle to form a 3D object (41);—a step (400) of merging the 3D objects (41) making it possible to generate a 3D map (42) of the obstacles all around the vehicle;—a step (500) of estimating the movement of the obstacle from the generated 3D map (42) and GPS data (43) of the vehicle to obtain information (44) on the position, size, orientation and speed of the vehicles detected in the area surrounding the vehicle.

### TECHNICAL FIELD

The invention relates in general to detection systems, and in particular to a device and a method for detecting one or more obstacles in the environment of a vehicle using sensors.

The automation of vehicles is a major challenge for motor vehicle safety and driving optimization. Automated vehicles, such as for example autonomous and connected vehicles, use a perception system comprising a set of sensors to detect environmental information allowing the vehicle to optimize its driving and making it possible to ensure passenger safety. Indeed, it is essential, in an autonomous driving mode, to be able to detect obstacles in the environment of the vehicle in order to adapt the speed and/or trajectory thereof.

To detect obstacles in the environment of the vehicle, it is known to use existing perception solutions based on autonomous sensors such as solutions in which a single frontal camera is responsible for detecting lane markings or any obstacle; or a combination of multiple sensors that are processed independently. This means that the output of a camera is fused with information that has already been processed originating from a lidar (acronym for the expression “light detection and ranging”). This processing of information may lead to significant errors, in particular due to the fact that the obstacle type identification capabilities are considerably greater when using a camera, while the distance and the speed of this obstacle are obtained better when using a lidar. Fusing the two types of information from a high-level perspective leads to an inconsistency, being able to identify a single vehicle ahead as multiple vehicles in front (that is to say an inconsistent inter-distance calculation when using two sensors operating independently) or a loss of target (that is to say two pedestrians walking too close to one another).

In particular, the solutions that are currently available are based primarily on automation levels 2 or 3 and are limited to a region of the image or have limited coverage.

Document U.S. Pat. No. 8,139,109 discloses a detection-based lidar and camera system, which may be in color or infrared. The system is used to supply controls to an autonomous truck. The system provides obstacle detection, but this detection is based on lidars and cameras operating separately. The information originating from the lidars and cameras is not fused. There is thus a need for a perception system capable of identifying and tracking any obstacle around the vehicle. An autonomous vehicle requires precise and reliable detection of the road surroundings in order to have a complete understanding of the environment in which it is navigating.

The invention aims to overcome all or some of the abovementioned problems by proposing a solution that is capable of providing 360-degree information over the cameras and the lidar, in accordance with the requirements of a fully autonomous vehicle, with detection and prediction of movements of vehicles and/or obstacles in the environment of the vehicle. This results in high-precision obstacle detection, thereby allowing the vehicle to navigate in the environment in complete safety.

### GENERAL DEFINITION OF THE INVENTION

To this end, one subject of the invention is a detection method implemented in a vehicle for detecting the presence of an obstacle in an environment of the vehicle based on data originating from a perception system on board the vehicle, the perception system comprising:

a. a lidar positioned on an upper face of the vehicle and configured to perform 360° scanning of the environment of the vehicle;
b. five cameras positioned around the vehicle, each of the cameras being configured to capture at least one image in an angular portion of the environment of the vehicle;
said method being characterized in that it comprises:
a step of scanning the environment of the vehicle by way of the lidar in order to obtain a point cloud of the obstacle;
for each camera, a step of capturing images in order to obtain a 2D representation of the obstacle located in the angular portion associated with said camera;
for each captured image, a step of assigning the points of the point cloud corresponding to the 2D representation of said obstacle in order to form a 3D object;
a step of fusing the 3D objects in order to generate a 3D map of the obstacles all around the vehicle;
a step of estimating the movement of the obstacle based on the generated 3D map and on GPS data of the vehicle in order to obtain information regarding the position, dimension, orientation and speed of vehicles detected in the environment of the vehicle.

In one embodiment, the detection method according to the invention furthermore comprises a control step implementing a control loop in order to generate at least one control signal for one or more actuators of the vehicle on the basis of the information regarding the detected obstacle.

Advantageously, the detection method according to the invention comprises a step of temporally synchronizing the lidar and the cameras prior to the scanning and image-capturing steps.

Advantageously, the step of assigning the points of the point cloud comprises a step of segmenting said obstacle in said image and a step of associating the points of the point cloud with the segmented obstacle in said image.

Advantageously, the step of fusing the 3D objects comprises a step of not duplicating said obstacle if it is present over a plurality of images and a step of generating the 3D map of the obstacles all around the vehicle.

Advantageously, the step of estimating the movement of the obstacle comprises a step of associating the GPS data of the vehicle with the generated 3D map, so as to identify a previously detected obstacle, and a step of associating the previously detected obstacle with said obstacle.

The invention also relates to a computer program product, said computer program comprising code instructions for performing the steps of the detection method according to the invention when said program is executed on a computer.

The invention also relates to a perception system on board a vehicle for detecting the presence of an obstacle in an environment of the vehicle, the perception system being characterized in that it comprises:
a lidar positioned on an upper face of the vehicle and configured to perform 360° scanning of the environment of the vehicle so as to generate a point cloud of the obstacle;
five cameras positioned around the vehicle, each of the cameras being configured to capture at least one image in an angular portion of the environment of the vehicle, so as to generate, for each camera, a 2D representation of the obstacle located in the angular portion associated with said camera;
a computer able to:
i. for each captured image, assign points of the point cloud corresponding to the 2D representation of said obstacle in order to form a 3D object;
ii. fuse the 3D objects in order to generate a 3D map of the obstacles all around the vehicle;
iii. estimate the movement of the obstacle based on the generated 3D map and on GPS data of the vehicle in order to obtain information regarding the position, dimension, orientation and speed of vehicles detected in the environment of the vehicle.

Advantageously, the perception system according to the invention furthermore comprises:
a sixth camera, preferably positioned at the front of the vehicle, the sixth camera having a small field of view for long-distance detection;
a seventh camera, preferably positioned at the front of the vehicle, the seventh camera having a wide field of view for short-distance detection;
   each of the sixth and/or seventh camera being configured to capture at least one image in an angular portion of the environment of the vehicle, so as to generate, for each of the sixth and/or seventh camera, a two-dimensional (2D) representation of the obstacle located in the angular portion associated with the sixth and/or seventh camera.

### BRIEF DESCRIPTION OF THE FIGURES

Further features, details and advantages of the invention will become apparent upon reading the description given with reference to the appended drawings, which are given by way of example and in which:

FIG. 1 shows a plan view of one example of a vehicle equipped with a perception system according to the invention;

FIG. 2 is a flowchart showing the method for detecting the presence of an obstacle in the environment of the vehicle according to some embodiments of the invention;

FIG. 3 illustrates the performance of the perception system according to some embodiments of the invention;

FIG. 4 illustrates the performance of the perception system according to some embodiments of the invention.

### DETAILED DESCRIPTION

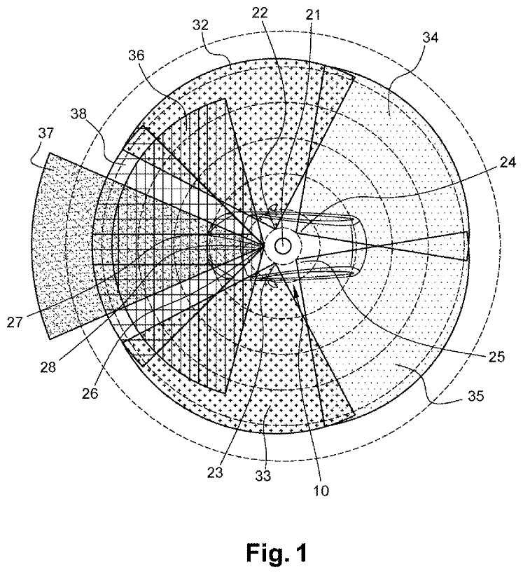

FIG. 1 shows a plan view of one example of a vehicle equipped with a perception system 20 according to the invention. The perception system 20 is carried on board a vehicle 10 in order to detect the presence of an obstacle in an environment of the vehicle 10. According to the invention, the perception system 20 comprises a lidar 21 advantageously positioned on an upper face of the vehicle 10 and configured to perform 360° scanning of the environment of the vehicle so as to generate a point cloud 31 of the obstacle. The perception system 20 comprises five cameras 22, 23, 24, 25, 26 positioned around the vehicle 10, each of the cameras 22, 23, 24, 25, 26 being configured to capture at least one image I₂, I₃, I₄, I₅, I₆ in an angular portion 32, 33, 34, 35, 36 of the environment of the vehicle 10, so as to generate, for each camera 22, 23, 24, 25, 26, a two-dimensional (2D) representation of the obstacle located in the angular portion 32, 33, 34, 35, 36 associated with said camera 22, 23, 24, 25, 26. Advantageously, but without being obligatory, the five angular portions 32, 33, 34, 35, 36 of the five cameras 22, 23, 24, 25, 26 cover the environment over 360° around the vehicle 10. The perception system 20 also comprises a computer able to assign, for each captured image I₂, I₃, I₄, I₅, I₆ points of the point cloud 31 corresponding to the 2D representation of said obstacle in order to form a three-dimensional (3D) object 41. The computer is able to fuse 3D objects 41 in order to generate a three-dimensional (3D) map 42 of the obstacles all around the vehicle 10. Finally, the computer is able to estimate the movement of the obstacle based on the generated 3D map 42 and on GPS data of the vehicle 10 in order to obtain information regarding the position, dimension, orientation and speed of vehicles detected in the environment of the vehicle 10.

The GPS data of the vehicle may originate from a GNSS (acronym for “Global Navigation Satellite System”) satellite positioning system if the vehicle is equipped with such a system. As an alternative, the GPS data may be provided by another source not included in the vehicle 10, for example by a GPS system via a smartphone.

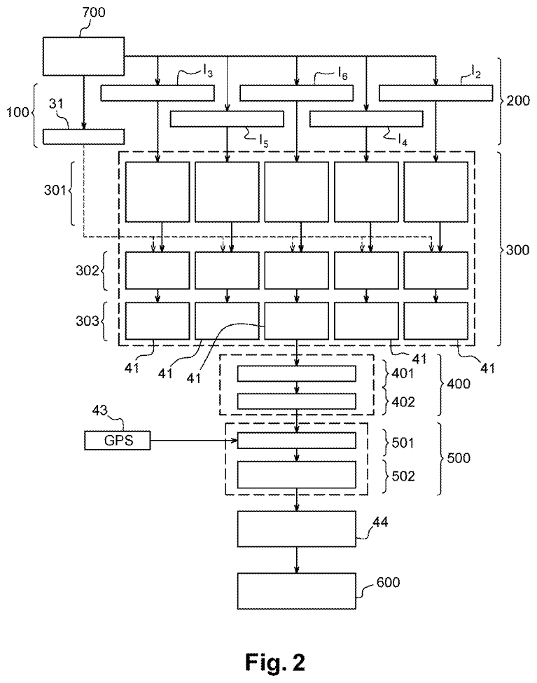

The steps of the detection method based on the perception system 20 will be described in detail below with reference to FIG. 2.

Advantageously, the perception system 20 according to the invention may furthermore comprise a camera 27 positioned at the front of the vehicle and having a small field of view for long-distance detection and/or a camera 28 positioned at the front of the vehicle and having a wide field of view for short-distance detection. Each of the cameras 27, 28 is configured to capture at least one image I₇, I₈ in an angular portion 37, 38 of the environment of the vehicle 10, so as to generate, for each camera 27, 28, a two-dimensional (2D) representation of the obstacle located in the angular portion 37, 38 associated with said camera 27, 28. These two additional cameras 27, 28 make it possible to capture images at a long range with a small field of view for any distant obstacles (camera 27) and at a short range with a high field of view for any obstacles close to the vehicle (camera 28). These cameras are advantageously positioned at the front of the vehicle in the preferred direction of travel of the vehicle. In another embodiment, these same cameras could be positioned at the back of the vehicle, for the direction of travel of the vehicle referred to as reverse. As another alternative, the vehicle may also be equipped with these two cameras 27, 28 positioned at the front and with two cameras identical to the cameras 27, 28 positioned at the back, without departing from the scope of the invention.

It may be noted that the cameras of the perception system 20 may operate in the visible or in the infrared.

By virtue of the invention, the perception system 20 is able to detect and/or identify any obstacle in its environment. The obstacles may be, by way of non-limiting example:
objects in the environment of the vehicle 10 possibly including fixed or mobile objects, vertical objects (for example traffic lights, signposts, etc.),
pedestrians,
vehicles, and/or
road infrastructures.

The invention is applied to particular advantage, but without being limited thereto, to the detection of obstacles that are pedestrians or vehicles that could generate a collision with the vehicle. By detecting the presence of an obstacle and where applicable the potential trajectory of the obstacle in the environment of the vehicle 10 in which the invention is implemented, the invention makes it possible to avoid the collision between the obstacle and the vehicle 10 by taking the necessary measures, such as braking of the vehicle 10, modifying its own trajectory and/or issuing an acoustic and/or visual signal or any other type of signal intended for the identified obstacle. If the obstacle is an autonomous vehicle, the measures needed to avoid a collision may very well also include sending a message to the obstacle asking it to brake and/or modify its trajectory.

The perception system 20 may furthermore implement fusion algorithms in order to process the information originating from the various cameras and the lidar and perform one or more perception operations, such as for example tracking and predicting the evolution of the environment of the vehicle 10 over time, generating a map in which the vehicle 10 is positioned, locating the vehicle 10 on a map, etc. These steps will be described below in the description of the detection method according to the invention based on FIG. 2.

FIG. 2 is a flowchart showing the method for detecting the presence of an obstacle in the environment of the vehicle 10 according to some embodiments of the invention.

The detection method according to the invention is implemented in a vehicle 10 in order to detect the presence of an obstacle in an environment of the vehicle 10 based on data originating from a perception system 20 on board the vehicle 10. As described above, the perception system 20 comprises:
a lidar 21 positioned on an upper face of the vehicle 10 and configured to perform 360° scanning of the environment of the vehicle 10;
five cameras 22, 23, 24, 25, 26 positioned around the vehicle 10, each of the cameras being configured to capture at least one image I₂, I₃, I₄, I₅, I₆ in an angular portion 32, 33, 34, 35, 36 of the environment of the vehicle. The five cameras 22, 23, 24, 25, 26 may be positioned around the vehicle 10 in order to capture portions of the environment of the vehicle 10. Advantageously, the five cameras 22, 23, 24, 25, 26 are positioned around the vehicle 10 such that the five cameras capture images in the environment of the vehicle over 360°.

The method comprises a step 100 of scanning the environment of the vehicle by way of the lidar 21 in order to obtain a point cloud 31 of the obstacle.

Lidar (abbreviation for light imaging detection and ranging) is a technology that makes it possible to measure distance between the lidar and an object. The lidar measures the distance to an object by illuminating it with pulsed laser light and by measuring the reflected pulses with a sensor. Within the context of the invention, the lidar 21 sends light energy into its environment, that is to say over 360°, all around the vehicle 10. This emitted light may be called a beam or a pulse. If there is an obstacle in the environment of the vehicle 10, the light emitted toward the obstacle is reflected toward the lidar 21 and the lidar 21 measures the light reflected toward a sensor of the lidar 21. This reflected light is called an echo or feedback. The spatial distance between the lidar 21 and the point of contact on the obstacle is computed by comparing the delay between the pulse and the feedback. In the presence of an obstacle in the environment of the vehicle 10, following step 100 of the method according to the invention, the lidar 21 makes it possible to have a point cloud of the obstacle. If there is another obstacle (for example one obstacle to the left and one obstacle to the right of the vehicle), the lidar 21 makes it possible to have two point clouds, one corresponding to the obstacle on the left and another corresponding to the obstacle on the right.

The lidar 21 has the advantage over other vision-based systems of not requiring light. It is able to detect objects with high sensitivity. The lidar 21 is thus able to precisely map the three-dimensional environment of the vehicle 10 with a high resolution. The laser feedback time and wavelength differences may be used to create 3D digital representations of objects surrounding the vehicle 10. However, it should be noted that the lidar 21 is not able to distinguish between the objects. In other words, if there are two objects of substantially identical shape and size in the environment of the vehicle, the lidar 21 on its own will not be able to distinguish between them.

The detection method according to the invention comprises, for each camera 22, 23, 24, 25, 26, a step 200 of capturing images I₂, I₃, I₄, I₅, I₆ in order to obtain a 2D representation of the obstacle located in the angular portion 32, 33, 34, 35, 36 associated with said camera 22, 23, 24, 25, 26. For example, with reference to FIG. 1, if an obstacle is present to the right of the vehicle in the angular portion 32, the camera 22 takes an image 12 that corresponds to a two-dimensional representation of the obstacle. After step 200, there are therefore five two-dimensional images I₂, I₃, I₄, I₅, I₆ of the environment of the vehicle 10.

The perception system 20 thus recovers the information from the cameras 22, 23, 24, 25, 26. The information recovered for each camera is processed separately, and then fused at a later stage, explained below.

The detection method according to the invention then comprises, for each captured image I₂, I₃, I₄, I₅, I₆, a step 300 of assigning the points of the point cloud 31 corresponding to the 2D representation of said obstacle in order to form a 3D object 41.

Step 300 may be divided into three sub-steps: a sub-step 301 of segmenting the obstacles, a sub-step 302 of associating the points of the point cloud 31 corresponding to the image under consideration with the segmentation of the obstacle and a sub-step 303 of estimating a three-dimensional object 41.

During step 300, for each received image 22, 23, 24, 25, 26, a convolutional neural network (also known by the abbreviation CNN) provides obstacle detection with instance segmentation based on the image. This makes it possible to identify the relevant obstacle in the surroundings of the vehicle 10, such as for example vehicles, pedestrians or any other relevant obstacle. The result of this detection is the segmented obstacle in the image, that is to say the shape of the obstacle in the image and its class. This is sub-step 301 of segmenting the obstacles. In other words, based on the captured two-dimensional images, sub-step 301 processes the images in order to recover the contour and the points of the obstacle. Reference is made to segmentation. At this stage, the information is in 2D form.

Once the obstacles have been detected and segmented in the area of the image under consideration, after sub-step 301, the points of the point cloud 31 of the lidar 21 that belong to each obstacle (that is to say the points 31 of the lidar 21 that are projected into the area of the image I₂ that belong to each obstacle) are identified. This is sub-step 302 of associating the points of the point cloud 31 with the segmentation of the obstacle. This sub-step 302 may be seen as the projection of the lidar points onto the corresponding segmented image. In other words, based on the image that is segmented (in two dimensions), projecting the lidar points makes it possible to obtain an object in three dimensions.

The quality of this segmentation depends greatly here on the precision of the calibration process. At this time, these points may include aberrant values due to the superposition of obstacles or errors in the detection and/or the calibration. In order to eliminate these errors, the method may comprise an estimation step aimed at removing the aberrant values, providing the estimated size, the center of the bounding box and the estimated rotation of the bounding box.

More precisely, sub-step 302 of associating the points of the point cloud 301 with the segmentation of the obstacle consists of a plurality of steps. First of all, the geometric structure behind the raw lidar data (point cloud 31) is recovered. This approach is capable of precisely estimating the location, the size and the orientation of the obstacles in the scene using only lidar information. To this end, it is necessary for the point cloud 31 to be segmented using image regions of interest. This is why the two-dimensional (2D) images 22, 23, 24, 25, 26 are used to extract 3D regions (called frustrums) from the point cloud 31, which are then supplied to the model in order to estimate the oriented 3D bounding boxes of the obstacles. By performing these steps, the 3D detection method of the invention receives, at input, a precise segmentation of the objects in the point cloud 31, thus taking advantage of the capabilities of the selected 2D detection box. This provides not only regions of interest in the image space, but also a precise segmentation. This processing differs from prior-art practices and leads to the removal of most of the points of the point cloud 31 that do not belong to the real object in the environment. This results in a finer obstacle segmentation in the lidar cloud before performing sub-step 303 of estimating a three-dimensional object 41, thus obtaining a better 3D detection result.

The estimation of the size, location and orientation of an obstacle is obtained as follows.

Assuming good calibration of the lidar 21, the information originating from the two sensors is associated by projecting the laser points onto the plane of the image (for example I₂). Once the RGB-D (red-green-blue-distance) data are available, the RGB information is used to extract the instance segmentation from the obstacles in the scene. Next, the masks of the obstacles are used to extrude the 3D information, obtaining the point cloud of the obstacles based on depth data, which are used as input for the 3D-oriented detection network.

First of all, the 3D coordinates and the intensity information regarding the points masked by the instance segmentation phase are used as input in a 3D instance segmentation network. The purpose of this model is to refine the representation of the obstacles in a point cloud, by filtering any aberrant values that might have been classified as obstacle points by the 2D detector. Thus, for each unique point of the masked obstacles, a confidence level is estimated, indicating whether the point belongs to the corresponding obstacle or, on the contrary, should be removed. This network therefore performs binary classification in order to distinguish between obstacle points and background points.

After the 3D segmentation step, the 3D bounding box of the obstacle is computed. This phase is divided into two different steps. First of all, a rough estimation of the center of the obstacle is made via a T-Net network. This model, also based on the PointNet architecture, aims to compute an estimate of the residual between the center of gravity of the masked points and the real center of the obstacle. Once the residual has been obtained, the masked points are translated into this new reference frame and then introduced into the final model. The purpose of this last network is to compute the final oriented 3D box of the obstacles (which is also called 3D object 41 in this description) from sub-step 303. Like its predecessors, this model follows a PointNet architecture. The output of the fully convolutional layers that are located after the feature encoder block represents the parameters of the obstacle box, including the dimensions, a finer central residual and the orientation of the obstacle.

After sub-step 303 of estimating a three-dimensional object 41, the detection method according to the invention comprises a step 400 of fusing the 3D objects 41, making it possible to generate a 3D map 42 of the obstacles all around the vehicle 10. Advantageously, but without being obligatory, the 3D map 42 of the obstacles around the vehicle is a 360° 3D map.

Step 400 of fusing the 3D objects comprises, once the information has been processed by a camera, identifying the camera that contains the most information per obstacle. Obstacles that fall within the field of view of multiple cameras are thereby not duplicated (sub-step 401). Hereinafter, after this removal, there is a single detection per obstacle, and by virtue of the lidar information, all are referenced to the same point, that is to say the origin of the lidar coordinates.

By virtue of this step, a complete 3D surroundings detection map 42 is created (sub-step 402), providing detection, advantageously over 360 degrees, based on a lidar camera.

Next, the detection method according to the invention comprises a step 500 of estimating the movement of the obstacle based on the generated 3D map 42 and on GPS data 43 of the vehicle 10 in order to obtain information 44 regarding the position, dimension, orientation and speed of the obstacle and/or of vehicles detected in the environment of the vehicle 10.

Step 500 of estimating the movement of the obstacle may be divided into two sub-steps: sub-step 501 of associating data, and sub-step 502 of associating the previously detected obstacle with said obstacle currently being detected.

Sub-step 502 of associating the previously detected obstacle with said obstacle makes it possible to maintain temporal coherence in the detections. In other words, the previous detections are associated with the new detections, and thus the movement of a specific obstacle may be estimated on the basis of a history of the detections. Furthermore, in the event of an incorrect detection, it is possible to maintain coherence of the tracking, that is to say to provide an output for an obstacle, even if it has been detected incorrectly.

Estimation step 500 is based on the use of a Kalman filter and on a data association technique that uses the Mahalanobis distance to correlate the old detection (that is to say the previous detection) with the up-to-date detection (that is to say the current detection).

Sub-step 501 of associating data aims to identify the previously detected obstacles within the current period. This is achieved using a greedy algorithm and the Mahalanobis distance. The greedy algorithm runs just after each prediction step of the Kalman filter, generating a cost matrix in which each row represents a tracking prediction and each column represents a new obstacle of the detection system. The value of the matrix cells is the Mahalanobis distance between each prediction and detection. The smaller this distance, the more probable the association between a prediction and a given detection.

The Mahalanobis distance represents the similarity between two multidimensional random variables. The main difference between Mahalanobis and Euclidean distance is that the former uses the value of the variance in each dimension. Dimensions suffering from a larger standard deviation (calculated directly by a Kalman filter) will thus have a smaller weight in the calculation of the distance.

The square root of the Mahalanobis distance calculated based on the output of the Kalman filter gives a chi-square distribution. Only if this value is less than or equal to a certain threshold value are the corresponding detection and prediction able to be associated. This threshold value is different for each obstacle type of a certain confidence level, which is different for each obstacle type.

As already mentioned, the sub-step of estimating the movement of the obstacle is based on the use of a Kalman filter. The original implementation of the Kalman filter is an algorithm designed to estimate the state of a linear dynamic system subject to interference by additive white noise. In the method according to the invention, it is used to estimate the movement (position, speed and acceleration) of the detected obstacles. However, the Kalman filter requires a linear dynamic system, and thus, in this type of application, alternatives such as the extended Kalman filter or the unscented Kalman filter are common. The tracking algorithm that is implemented uses the “square root” version of the unscented Kalman filter. The unscented version of the Kalman filter allows us to use non-linear movement equations to describe the movement and the trajectory of the tracked obstacles. In addition, the “square root” version provides the Kalman filter with additional stability, since it always guarantees a positive definite covariance matrix, avoiding number errors.

The UKF (abbreviation for “Unscented Kalman Filter”) tracking algorithm that is presented operates in two steps. The first step, called prediction step, uses the state estimation of the previous time increment to produce an estimation of the state in the current time increment. Later on, in the update stage, the current prediction is combined with the current observation information to refine the previous estimation. As a general rule, these two steps alternate, but, if an observation is not available for any reason, the update may be ignored and multiple prediction steps may be performed. In addition, if multiple independent observations are available at the same time, multiple update steps may be performed. For this approach, each obstacle type is associated with a system model. This model consists of a series of kinematic equations describing its movement. In the prediction step, these movement equations are used to estimate the position of the obstacles at each time increment. Next, in the update step, a noisy measurement of the position of the obstacle results from the detection step, and the estimation of the state of the system is improved. Cyclists and automobiles have a more complex associated system model since they are able to travel more quickly and their trajectory comprises higher accelerations and more complex turns.

When a tracked obstacle is not able to be associated with a new detection at a given time, this obstacle remains in a state of invisibility and continues to be tracked in the background. This provides temporary coherence to the detections in the event of failure of the perception system. Each obstacle is assigned an associated score. The value of this score increases each time the tracking algorithm associates a new detection with a tracked obstacle and decreases each time the obstacle is in a state of invisibility. Below a certain predefined threshold, the obstacle is eliminated.

The use of a tracking algorithm makes it possible to make the predictions at a higher frequency than the perception system. This results in an increase in the output frequency by up to 20 Hz.

Estimation step 500 may advantageously comprise a sub-step of taking into account the movement specific to the vehicle 10. Indeed, the movement of the vehicle may introduce errors into the movement of the tracked obstacles. This is why it is necessary to compensate for this movement. To achieve this aim, the GPS receiver is used.

At the start of each iteration of the algorithm, the orientation of the vehicle is obtained using the inertial sensor. The new detections are then oriented using the orientation value of the vehicle before being introduced into the Kalman filter, thus compensating for the orientation of the vehicle. At the output of the algorithm, the inverse transformation is applied to the obstacles. Proceeding in this way makes it possible to obtain output detections expressed in the local coordinate system of the vehicle.

The invention thus makes it possible to create a behavioral model of the vehicle by obtaining information regarding the vehicles/obstacles in the environment of the vehicle. This output is the class of the obstacle provided by the initial detection, the size, provided in the estimation algorithm, of the bounding box and the location, the speed and the orientation provided by the tracking algorithm.

Advantageously, the detection method according to the invention may furthermore comprise a control step 600 implementing a control loop in order to generate at least one control signal for one or more actuators of the vehicle 10 on the basis of the information regarding the detected obstacle. An actuator of the vehicle 10 may be the brake pedal and/or the handbrake, which is/are actuated in order to perform emergency braking and immobilize the vehicle before avoiding a collision with the obstacle. Another actuator of the vehicle 10 may be the steering wheel, which is oriented so as to modify the trajectory of the vehicle 10 in order to avoid a detected obstacle.

Advantageously, the detection method according to the invention may comprise a step 700 of temporally synchronizing the lidar and the cameras prior to scanning and image-capturing steps 100, 200. Step 700 makes it possible to synchronize the lidar 21 and the cameras 22, 23, 24, 25, 26 at a precise instant. Temporal synchronization step 700 may take place at regular or irregular intervals in a manner predefined beforehand. As another alternative, temporal synchronization step 700 may take place just once per journey, for example after the vehicle 10 has been started.

The embodiments of the invention thus make it possible to detect the presence of an obstacle in an environment of the vehicle, and if necessary to generate at least one control signal for one or more actuators of the vehicle on the basis of the information regarding the detected obstacle. They thus allow the vehicle to avoid any collision with an obstacle.

Although they are not limited to such applications, the embodiments of the invention are particularly advantageous for implementation in autonomous vehicles.

A person skilled in the art will understand that the system or subsystems according to the embodiments of the invention may be implemented in various ways in the form of hardware, software, or a combination of hardware and software, in particular in the form of program code able to be distributed in the form of a program product, in various forms. In particular, the program code may be distributed using computer-readable media, which may include computer-readable storage media and communication media. The methods described in the present description may in particular be implemented in the form of computer program instructions able to be executed by one or more processors in a computer processing device. These computer program instructions may also be stored in a computer-readable medium.

Moreover, the invention is not limited to the embodiments described above by way of non-limiting example. It encompasses all variant embodiments that might be envisaged by a person skilled in the art. In particular, a person skilled in the art will understand that the invention is not limited to particular types of sensor of the perception system, or to a particular type of vehicle (examples of vehicles include, without limitation, automobiles, trucks, buses, etc.).

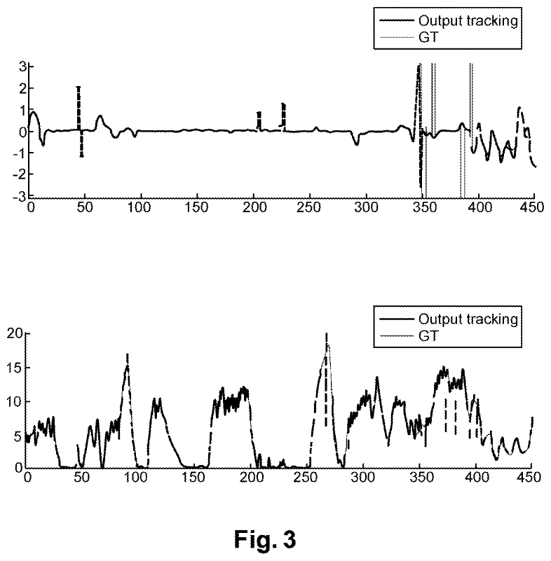

FIG. 3 illustrates the performance of the perception system according to some embodiments of the invention.

To validate the perception system according to the invention, two vehicles equipped with high-precision positioning systems were used. Their positions, speeds and orientations were recorded. FIG. 3 shows the orientation (top graph) and the speed (bottom graph) as a function of time (in seconds) of a reference vehicle (ground truth, denoted GT) and of a vehicle equipped with the perception system according to the invention (denoted “Output tracking”). It may be seen that the curves are superimposed and thus show the performance of the perception system according to the invention against the ground truth.

As may be seen, the system of the invention proves its performance and the reliability of the detections. The performance in terms of the orientation response is particularly remarkable, with a small tracking error.

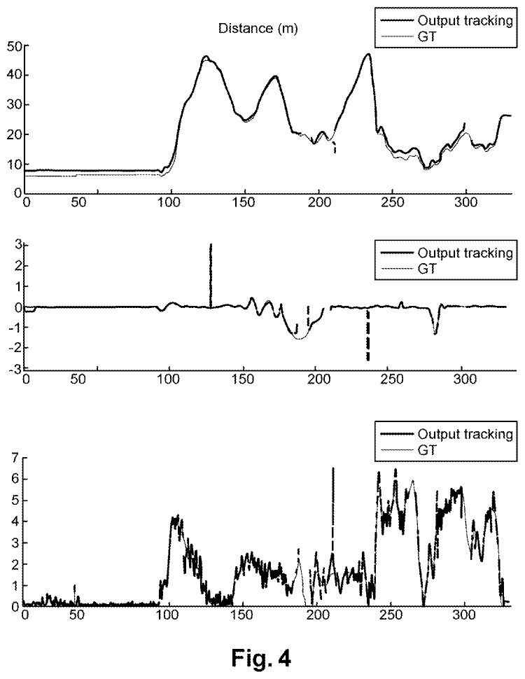

FIG. 4 shows the detections of the distance to the obstacle (top graph), the orientation (middle graph) and the speed (bottom graph) of the vehicle detected in front of the vehicles equipped (reference vehicle (ground truth, denoted GT) and vehicle equipped with the perception system according to the invention (denoted “Output tracking”)) in a running sequence different from that shown in FIG. 3. As may be seen, the perception system according to the invention proves its performance and the reliability of the detections.

All of these tests were performed in real traffic, under normal driving conditions. For the sake of clarity, we have just shown the performance following one vehicle in front of the equipped vehicle, but good results were also obtained when tracking multiple obstacles, including pedestrians.

The detection method according to the invention offers a complete perception solution over 360 degrees for autonomous vehicles, based on a lidar and five cameras. The method may use two other additional cameras for greater precision. This method uses a new sensor configuration, for low-level fusion based on cameras and a lidar. The solution proposed by the invention provides detection of class, speed and direction of obstacles on the road.

It may be noted that the perception system according to the invention is complete and may be deployed in any autonomous vehicle. The advantage of the invention is that of increasing the safety of the vehicle by identifying other vehicles/obstacles in the environment of the vehicle and by anticipating their movements. Modern vehicles have limited perception capabilities, and this solution provides a complete solution over 360 degrees based on low-level detection.

Although it is designed for autonomous vehicles, the solution may be adapted to any vehicle offering complete understanding of the situation of the vehicles on the road. Indeed, this solution is applicable to any vehicle structure. The perception system according to the invention is applicable in particular to any type of transport, including buses or trucks.

1. A detection method implemented in a vehicle (10) for detecting the presence of an obstacle in an environment of the vehicle (10) based on data originating from a perception system (20) on board the vehicle (10), the perception system (20) comprising:
a. a lidar (21) positioned on an upper face of the vehicle (10) and configured to perform 360° scanning of the environment of the vehicle (10);
b. five cameras (22, 23, 24, 25, 26) positioned around the vehicle (10), each of the cameras being configured to capture at least one image (I₂, I₃, I₄, I₅, I₆) in an angular portion (32, 33, 34, 35, 36) of the environment of the vehicle;
said method being characterized in that it comprises:
a step (100) of scanning the environment of the vehicle by way of the lidar (21) in order to obtain a point cloud (31) of the obstacle;
for each camera (22, 23, 24, 25, 26), a step (200) of capturing images (I₂, I₃, I₄, I₅, I₆) in order to obtain a 2D representation of the obstacle located in the angular portion (32, 33, 34, 35, 36) associated with said camera (22, 23, 24, 25, 26);
for each captured image ((I₂, I₃, I₄, I₅, I₆), a step (300) of assigning the points of the point cloud (31) corresponding to the 2D representation of said obstacle in order to form a 3D object (41);
a step (400) of fusing the 3D objects (41) in order to generate a 3D map (42) of the obstacles all around the vehicle (10);
a step (500) of estimating the movement of the obstacle based on the generated 3D map (42) and on GPS data (43) of the vehicle (10) in order to obtain information (44) regarding the position, dimension, orientation and speed of vehicles detected in the environment of the vehicle (10).

2. The detection method as claimed in claim 1, characterized in that it furthermore comprises a control step (600) implementing a control loop in order to generate at least one control signal for one or more actuators of the vehicle on the basis of the information regarding the detected obstacle.

3. The detection method as claimed in either one of claims 1 and 2, characterized in that it comprises a step (700) of temporally synchronizing the lidar and the cameras prior to the scanning and image-capturing steps (100, 200).

4. The detection method as claimed in any one of claims 1 to 3, characterized in that the step (300) of assigning the points of the point cloud (31) comprises a step (301) of segmenting said obstacle in said image and a step (302) of associating the points of the point cloud (31) with the segmented obstacle in said image.

5. The detection method as claimed in any one of claims 1 to 4, characterized in that the step (400) of fusing the 3D objects (41) comprises a step (401) of not duplicating said obstacle if it is present over a plurality of images and a step (402) of generating the 3D map (42) of the obstacles all around the vehicle (10).

6. The detection method as claimed in any one of claims 1 to 5, characterized in that the step (500) of estimating the movement of the obstacle comprises a step (501) of associating the GPS data (43) of the vehicle (10) with the generated 3D map (42), so as to identify a previously detected obstacle, and a step (502) of associating the previously detected obstacle with said obstacle.

7. A computer program product, said computer program comprising code instructions for performing the steps of the method as claimed in any one of claims 1 to 6 when said program is executed on a computer.

8. A perception system (20) on board a vehicle (10) for detecting the presence of an obstacle in an environment of the vehicle (10), the perception system being characterized in that it comprises:
a. a lidar (21) positioned on an upper face of the vehicle (10) and configured to perform 360° scanning of the environment of the vehicle so as to generate a point cloud (31) of the obstacle;
b. five cameras (22, 23, 24, 25, 26) positioned around the vehicle (10), each of the cameras (22, 23, 24, 25, 26) being configured to capture at least one image (I₂, I₃, I₄, I₅, I₆) in an angular portion (32, 33, 34, 35, 36) of the environment of the vehicle (10), so as to generate, for each camera (22, 23, 24, 25, 26), a 2D representation of the obstacle located in the angular portion (32, 33, 34, 35, 36) associated with said camera(22, 23, 24, 25, 26);
c. a computer able to:
i. for each captured image (I₂, I₃, I₄, I₅, I₆), assign points of the point cloud (31) corresponding to the 2D representation of said obstacle in order to form a 3D object (41);
ii. fuse the 3D objects (41) in order to generate a 3D map (42) of the obstacles all around the vehicle (10);
iii. estimate the movement of the obstacle based on the generated 3D map (42) and on GPS data of the vehicle (10) in order to obtain information regarding the position, dimension, orientation and speed of vehicles detected in the environment of the vehicle (10).

9. The perception system (20) as claimed in claim 8, characterized in that it furthermore comprises:
a. a sixth camera (27), preferably positioned at the front of the vehicle (10), the sixth camera having a small field of view for long-distance detection;
b. a seventh camera (28), preferably positioned at the front of the vehicle (10), the seventh camera having a wide field of view for short-distance detection;
each of the sixth and/or seventh camera (27, 28) being configured to capture at least one image (I₇, I₈) in an angular portion (37, 38) of the environment of the vehicle (10), so as to generate, for each of the sixth and/or seventh camera (27, 28), a two-dimensional (2D) representation of the obstacle located in the angular portion (37, 38) associated with the sixth and/or seventh camera (27, 28).
